(19) United States
(12) Patent Application Publication
(10) Pub. No.: US 2012/0091732 A1
(43) Pub. Date: Apr. 19, 2012

(54) POWER GENERATING APPARATUS WITH AN ANNULAR TURBINE

(76) Inventors: Truls Fallet, Oslo (NO); Olav Storstrøm, Oslo (NO); Gisle Onsrud, Vikhammer (NO); Bjørnar Lund, Trondheim (NO)

(21) Appl. No.: 13/380,211

(22) PCT Filed: Jun. 24, 2010
(86) PCT No.: PCT/NO10/00243

§ 371 Date: Dec. 22, 2011

(30) Foreign Application Priority Data
Jul. 3, 2009 (NO) 2009-2520

(51) Int. Cl. H02K 7/18; H02P 9/04

(52) U.S. Cl. 290/40 R; 290/52

(57) ABSTRACT

The present invention concerns a power generating apparatus for generating power from a fluid flowing in a pipe (14). The apparatus includes a cylindrical body (13), and an annular turbine (4) for driving an electric generator. Fluid bearings (8, 9, 10) support the turbine (4). A central flow passage (17) extends through the entire power generating apparatus. A fluid conditioner stage removes contamination of solid particles from the fluid, for conditioning the fluid before entering the fluid bearing (8, 9, 10), lubricated by the fluid. A first static flow shaper (1) is included in the fluid conditioner stage for providing a rotating vortex flow acting to concentrate the contamination of solid particles in a flow along an outer circumference of the apparatus and an uncontaminated flow to the bearings (8, 9, 10).

The present invention concerns a power generating apparatus for generating electric power from a fluid flowing in a pipe. The apparatus includes an annular turbine supported on the outside of a tubular housing. The apparatus may be configured for installation almost anywhere in a well or pipe.

Electric power is frequently needed in pipes and in particular for downhole monitoring and control in a well, but other areas may include monitoring and transmitting data in oil or gas lines for providing information related to such parameters as flow rate, pressure, temperature, aggregation of scale, deposits etc. and to transmit the data to a control unit. Electric power downhole may also be used for opening or closing valves, analyzing downhole fluids, taking fluid samples, removal of scale build-up etc.

Other uses of electric power in wells includes wireless communication that is becoming an effective tool to achieve monitoring and control of petroleum wells, in particular within the field “inflow control” and “intelligent wells”. In particular situations, it is desirable to perform measurements on, and in some cases choke the flow of fluid in to the well from a particular zone of the well. Electricity may be conveyed downhole by wire-line cables, but the use of wire-line cables is considered complicated and unfavourable in many situations, and the zones in question are often not practically accessible with a cable, such that energy for measurement and control must be provided on location. Other systems utilize electric accumulators/batteries but these have obvious limitations.

Of practical reasons it is in many cases not acceptable to block the entire cross section of the well with an apparatus for providing electrical energy. Accordingly it is necessary to utilise the thin annulus formed between for instance a casing and a straddle packer to allow well operations to be performed.

Various downhole power generators with turbines and alternators, typically driven by the flow of drilling mud have been developed, but these generators are not adapted for use with produced fluids.

Various systems using mud have been developed to alleviate for providing electric power in wells, but these generators are typically operated during drilling. In EP 0 747 568 it is described a LWD tool positioned in a hollow drill string and sized to form an annular passage between the drill string and tool body, through which passage drilling fluid is circulated. The tool includes a turbine with turbine blades driving an alternator. The tool may include a deflector screen for causing a portion of the well fluid to bypass the turbine blades, only allowing filtered flow to pass through the turbine blades, thus reducing the risk of plugging or jamming by debris. Particles which are to large to pass through the screen/deflector are deflected to the outside of a bypass sleeve and through a flow bypass.

In FR 2 867 627 it is shown a downhole alternator with an external rotor or turbine. In the shown solution may drilling fluids enter a gap between a stator and the rotor/turbine via a port to lubricate and cool the alternator and the bearings. Larger entrained particles are diverted from the port by the action of stator vanes and an angled port layout. The alternator is however intended for use in connection with drilling fluids or mud, and is not intended for use in connection with produced fluids such as oil, gas and water.

In U.S. Pat. No. 7,537,051 it is described a downhole power generation assembly with a downhole tool string component comprising a bore. A collar is rotatably supported within the bore and has a centralized fluid passageway and a plurality of turbine blades. The collar is connected to a power generation element such that rotation of the collar moves the power generation element and induces an electrical current.

It may however inn some cases be advantageous to be able to install an apparatus for generating electric energy in a pipe or any tubular part, and to generate power from the fluid flowing in the pipe. The fluid in this connection may be gas flowing in a gas line, oil flowing in an oil line etc., but is will normally not be a fluid particularly for driving purposes such as drilling mud.

The present invention concerns such an apparatus. The apparatus of the invention is particularly intended as a downhole generator generating power from the produced fluids in a hydrocarbon well, but is not restricted to that use. It is an object of the present invention to provide a generator that will allow tools to be conveyed in the pipe, past the generator, in particular downhole, and to provide an apparatus that allows access for downhole tools through the apparatus. In a well for producing hydrocarbons, the pipe will typically be a casing, a liner or some kind of production tubing. The produced fluid will typically be a multiphase fluid of oil, water, gas and solid particles. A considerably lower amount of power may be available compared to systems generating power from circulated mud, but the available power may still be sufficient for powering various components.

Furthermore it is a purpose of the invention to provide a more reliable generator where more of the solid particles entrained in the flow are removed from the flow entering the turbine.

The invention may be used in two different modes of operation.

One mode is when the apparatus of the invention is placed over perforations in the pipe and a difference in pressure between the outside and the inside of the pipe is used to drive the turbine. In this mode may all the fluid flowing through the perforations be led into the apparatus of the invention, and the flow rate may typically be small.

A second mode is when an apparatus of the invention is placed in a restriction in the pipe. A difference in pressure over the restriction is then used to drive the turbine.

Furthermore it is a purpose of the present invention to provide an apparatus where the mayor part of the fluid bypasses the apparatus at the centre of the apparatus. In some conditions it may however be necessary to restrict the flow rate bypassing the turbine by including some sort of restriction to increase the flow rate through the turbine.

The present invention concerns a power generating apparatus for generating power from a fluid flowing in a pipe The apparatus includes a cylindrical body, and an annular turbine for driving an electric generator. Furthermore, the apparatus includes fluid bearings for supporting the turbine, a central flow passage extending through the entire power generating apparatus, a fluid conditioner stage for removing contamination of solid particles from the fluid, for conditioning the fluid before entering the fluid bearing, lubricated by said fluid, and a first static first flow shaper included in the fluid conditioner stage for providing a rotating vortex flow acting to concentrate the contamination of solid particles in a flow along an outer circumference of the apparatus and an uncontaminated flow to the bearings.

The turbine will typically be made of a light material with good wear properties such as titanium.

The generator may be connected to an electronic controller optimizing the electric load over a wide range in flow rates and flow regimes.

The fluid will typically be a combination of oil, water and gas of varying density and viscosity and is normally contaminated by sand. The pressure, temperature and flow rate variation may be considerable.

The cylindrical body defines a first cross sectional area and the opening defines a second cross sectional area. The second area may be greater than the first area. In other words, the apparatus may leave most of the well open to allow well tools to pass, or a more or less unrestricted fluid flow. The diameter of the flow passage may accordingly be sufficient to allow downhole tools to pass.

Fluid for the fluid bearings may be provided by the same primary fluid driving the turbine. The bearing may be formed as a small annulus between the turbine and the housing wall and may form a hydrodynamic radial bearing for the turbine. Axial support for the turbine may be achieved by inclined bearing faces. The upper part of the bearing faces may include radial recesses or grooves to provide a radial pumping effect to contribute to pump fluid through the bearing. Axial grooves may ensure even distribution of the lubricating fluid over the bearing faces and collection of contaminants such as grains of sand that have been entrained in the fluid flow.

The fluid bearings may provide both radial and thrust support and may act to centralize the turbine towards a radial and an axially position.

The radial and thrust support may be provided by a pressure differential across the turbine. Furthermore the apparatus may utilize magnetic bearings as a substitute for, or in addition to the fluid bearings.

The fluid conditioning stage removes contamination from the fluid, and conditions the fluid before entering the fluid bearings, lubricated by said fluid.

The generator may be connected to an electronic controller optimizing the electric load over a wide range in flow rates and flow regimes. The performance of the apparatus is a trade off between power, cogging torque and fluid support, and the performance may be controlled by the electronic controller for optimized the output.

The controller may ensure optimal power generation and operational life and the controller may be an electronic power controller. The controller may allow autonomous optimization of the generator based on measured local environmental parameters, such as load from attached devices, operating temperature, or flow in the well. Accordingly, the apparatus may include sensors or other means for measuring the local environmental parameters. One way of controlling the apparatus is to reconfigure the generator coil wiring to adjust the performance.

The control means may match the electrical output from the generator to be suited for battery charging as well as for powering downhole signal transmitters and measurement electronics. The control means may alter the ratio of flow between the inner and outer passageways.

The rotor and stator may be magnetically balanced to provide radial suspension reducing radial bearing requirements, in particular at start up conditions.

A conditioning assembly including the first stationary guide vanes may provide conditioning, separation or cleaning of the fluid by providing a vortex or a hydro cyclone action, by imposing a rotation on the fluid such that heavy solid particles are concentrated along the outer edges of the apparatus. Accordingly, the vortex provides a substantially particle free fluid phase entering flow passageways in the bearings for lubrication and centralisation of the turbine.

The conditioning assembly or stage may also utilise several guide vanes to optimize fluid angle of attack and to minimize thrust forces and net radial bearing force. The fluid may be a multiphase fluid, and multiphase fluids have a tendency to cause asymmetric loads on the components. The guide vanes will also tend to provide a homogenous phase flowing over the turbine in a multiphase flow.

The turbine blade design, pre flow conditioners are optimized to maximize power generation while minimizing thrust.

The turbine blades leading and trailing edges may be symmetrical.

The cylindrical body may be designed to be locked into an existing wellbore tubular.

The apparatus can be inserted into an existing wellbore using a wire line or coiled tubing, and may include areas for connection to, or release from such elements, and the apparatus may be set in a pipe or well in a conventional way. The apparatus may further include an outer, cylindrical protective housing to protect the apparatus when deployed.

The apparatus may further include communications means and the communication means may relay operational parameters to another device in the wellbore or to the surface.

The apparatus may also include control means wherein optimal power generation and operational life is ensured using an electronic power controller. The control means may allow autonomous optimization of the generator based on local environmental conditions. The environmental conditions may include load from attached devices, operating temperature, or flow in the tubular. The control means may reconfigure the generator coil wiring to adjust the performance. The control means may match the electrical output from the generator to be suited for battery charging as well as powering downhole signal transmitters and measurement electronics. The control means may also be designed to alter the ratio of flow between the inner and outer passageways. The flow may be altered by including a sliding sleeve over the inlet or outlet ports, and actuators may adjust the sleeve based on measured parameters from for instance sensors and the power controller.

### SHORT DESCRIPTION OF THE ENCLOSED FIGURES

FIG. 1 is a schematic representation in cross-section of a first embodiment of the invention;

FIG. 2 is a cross-section perpendicular to the cross-section of FIG. 1, of the same embodiment as FIG. 1;

FIG. 3 is a cross-section of a second embodiment of the invention;

FIG. 4 is a perspective view of a third embodiment of the invention;

FIG. 5 is a cross-section of the third embodiment; and

FIG. 6 is a side elevation of a forth embodiment of the invention.

### DETAILED DESCRIPTION OF EMBODIMENTS OF THE INVENTION WITH REFERENCE TO THE ENCLOSED FIGURES

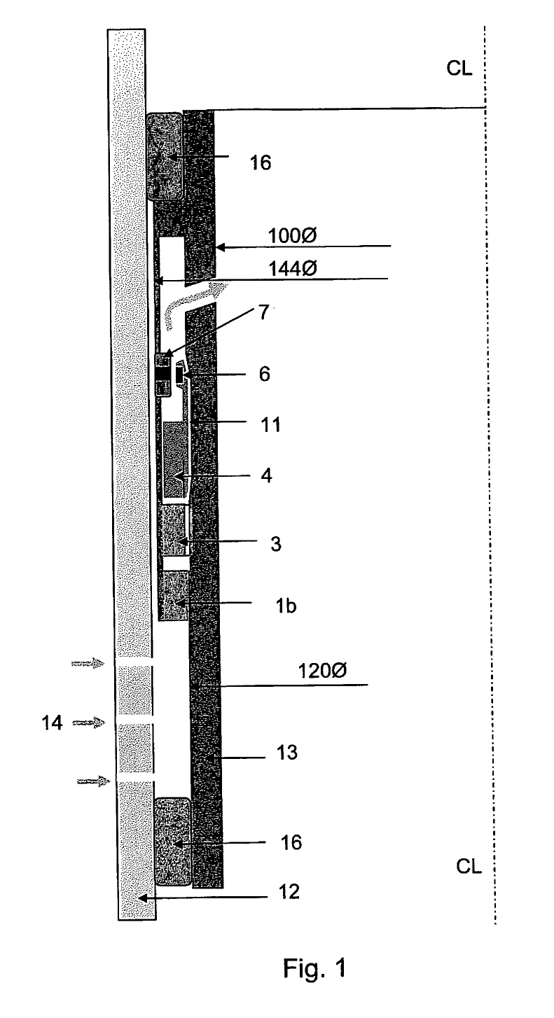

FIG. 1 is a schematic representation of a cross-section of a first embodiment of an apparatus according to the invention, in a first mode of operation when the apparatus of the invention is placed over perforations or inlets 14 in a pipe 12 such as a casing and a difference in pressure between the outside and the inside of the pipe is used to drive the turbine 4. Fluid, typically produced fluids in a well, can flow through the inlet 14, past an inlet cyclone 1b generating a vortex around a cylindrical body 13, housing or straddle packer wall, a flow shaper 3 for further accelerating the vortex or rotating flow, a turbine 4 rotated by the rotating flow from the flow shaper 3, magnets 6 attached to, and rotated by the turbine 4, pick up coils 7 for generating electric power from a rotating magnetic field provided by the magnets 6, and an outlet 15 for the fluid above the turbine 4. Lubrication channels 11 provide fluid to the bearings for the turbine 4. The inlet cyclone 1b generating a vortex, separates contaminations in the form of solid particles from the fluid as the solid particles will tend to move along the outer diameter, whereas uncontaminated fluid along the inner diameter of the housing 13 can be led through the lubrication channels 11 and to the bearings of the turbine 4. The separating effect may be compared to the effect of a hydro cyclone. The outlet 15 may be formed as a sliding sleeve valve for controlling the flow rate through the apparatus. The turbine, flow shaper and pick up coils are placed in a tubular element, for instance a straddle packer that provides a housing 13 for the assembly of the invention. Packers 16, seal between the pipe 12 such as the pipe and the housing 13. The magnets 6 may be permanent magnets attached to the turbine and the system with the magnets and the pick up coils may contribute to stabilize the axial position of the turbine, and the radial magnetic forces may be accurately balanced to reduce the need for radial bearing forces.

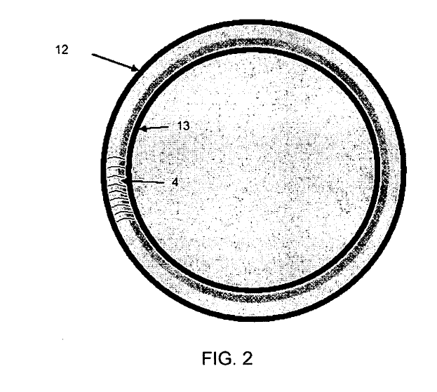

FIG. 2 is a cross-section of the pipe such as the pipe with the assembly of the invention as shown on FIG. 1, where the turbine 4 is shown as an annular turbine ring outside the housing 13 and inside the pipe 12 such as the casing.

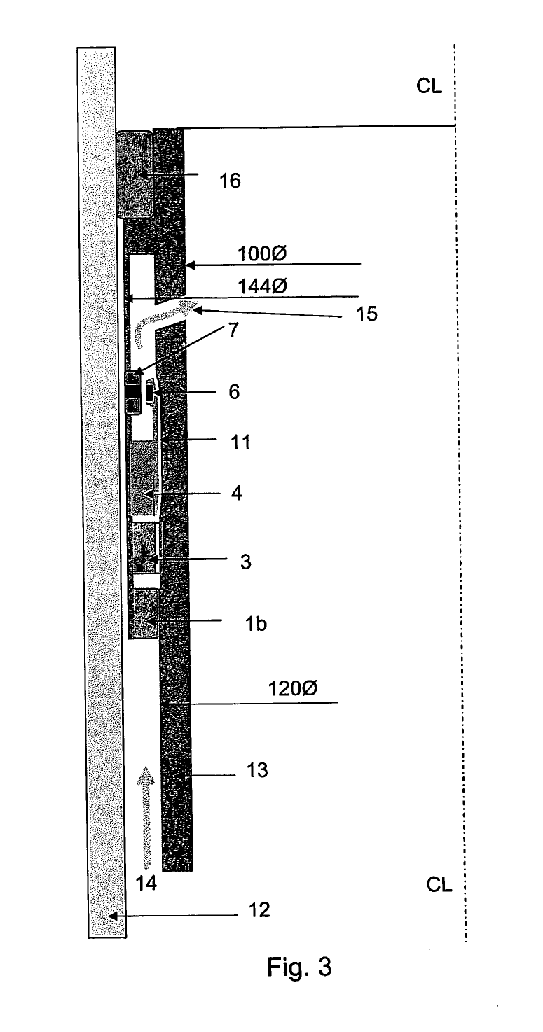

FIG. 3 corresponds in many aspects to FIG. 1, but shows a second mode where an apparatus of the invention is placed in a restriction in the pipe. A difference in pressure over the restriction is then used to drive the turbine. FIG. 3 shows hence a slightly different embodiment of the invention. In FIG. 3, flow is taken from inside the pipe 12, through inlet 14, past an inlet cyclone 1b generating a vortex around the housing 13, past the static flow shaper 3, past the rotating turbine 4, out through the outlet 15 and back into the pipe 12. A packer 16 seals between the housing 13 and the pipe 12. The pipe 12 may of course be any liner, casing or tubular element with an internal flow. A part of the fluid flowing through the assembly of the invention may be led through lubrication channels 11 that may form pressurized lubricating channels. A second part of the fluid possibly with contaminations, may flow may flow along the pipe 12, and out through the outlet 15. At the embodiment of FIG. 3, the magnets 6 are placed above the turbine 4, and generate electric power in the static generator coils 7, placed outside of and adjacent to the magnets 6.

The inner diameter of the housing 13 may typically be 100 mm, the outer diameter of the housing may typically be 144 mm and the inner diameter of the turbine may typically be 120 mm.

The apparatus of the invention may be only 10 mm thick even if the well diameter is about 150 mm, leaving an opening through the apparatus with a diameter of 130 mm.

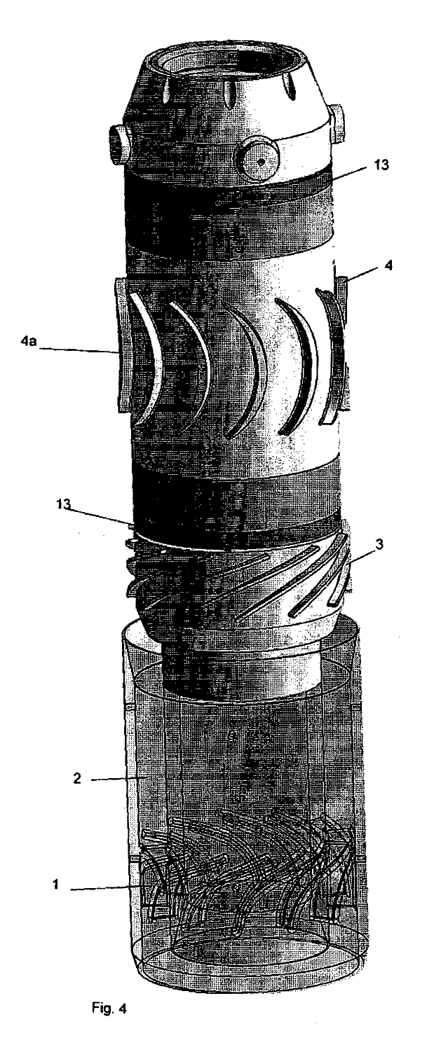

FIG. 4 is a perspective view of a third embodiment of the invention where first static flow shapers 1 are placed at an inlet for fluid. The flow shapers 1 guides the fluid into rotation, such that contamination in the form of solid particles are put into rotation and will tend to move along the outer wall of the cyclone chamber 2, whereby a flow of fluid without solid particles is provided along the housing 13. This cleaned fluid may then be used in the hydrodynamic bearings of the turbine 4. Second flow shapers 3, further accelerate the flow of fluid to provide a rotating flow that will impinge on the turbine blades 4a to rotate the turbine 4. The turbine blades 4a are curved to guide the rotating flow in an opposite direction, such that the rotation of the fluid above the turbine is considerably reduced to improve the efficiency of the assembly.

The turbine ring may be hydro dynamically suspended in a radial and axial direction by clean well fluids flowing in the clearances between the turbine ring 4 and the tubular housing 13. The fluids may be cleaned by a hydrodynamic cyclone action in the flow shaper 3 where heavy particles such as sand are removed from the fluid used for dynamic suspension. Low static friction between the components can be ensured through material selection in the self-cleaning bearing areas for providing low static friction during start up. The annulus flow direction can be chosen to compensate gravity forces on the turbine.

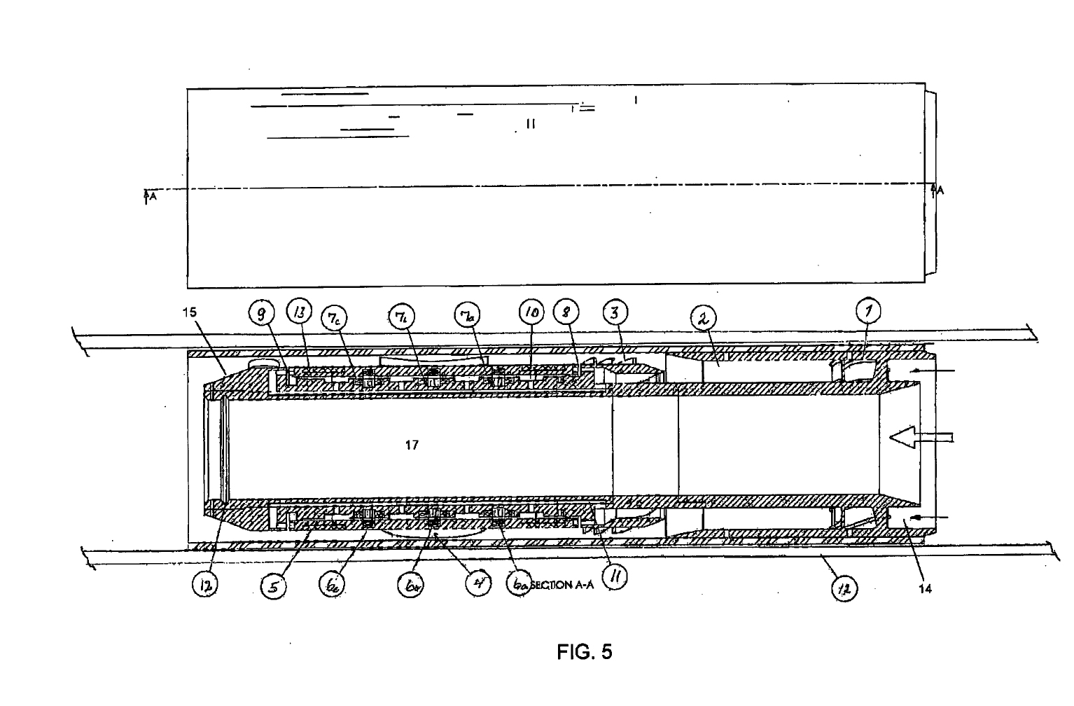

FIG. 5 is a cross-section of the embodiment shown on FIG. 4, where the various components are shown in greater detail. FIG. 5 clearly shows how fluid will flow through the inlet 14, past the static first flow shaper 1, past the cyclone chamber 2, past the second flow shaper 3, past the turbine 4 and back into the pipe 12 through the outlet 15.

Solid particles in the fluid entering the inlet 14 will tend to move along the outer wall of the cyclone chamber 2, whereas a substantially solid free fluid will move along the inner wall of the cyclone chamber 2, further flow into the axial thrust bearing 8, the radial bearing 10, the pressurized lubrication channels 11 and back into the remaining flow of the fluid. Accordingly, a gap may be provided between the pipe 12 and the tip of the blades of the turbine 4 for providing an undisturbed fluid path for the contaminated fluid along the inner wall of the pipe, and for preventing abrasive action of the contaminated fluid on the turbine.

Annular magnets 6a, 6b and 6c are shown placed on the annular turbine 4, and these magnets 6a, 6b, 6c are aligned with generator pick up coils 7a, 7b and 7c. The well flow will flow from the right on FIG. 5, indicated by the arrows. The flow will be distributed between the centre opening that normally will lead the major part of the flow and the flow in the annulus that is partly used to drive the turbine and partly to provide a flow of fluid in the bearing faces. The driving pressure for the turbine and the lubrication of the bearings is a result of the hydrodynamic difference of pressure between the inlet side and the outlet side of the tubing that leads the main flow.

The fluid flow flowing along the inner wall will be led into the pressure lubrication channels 11 to feed both the axial thrust bearings 8 and 9 and the radial bearing 10. All the bearings are designed such that the turbine is led towards a neutral position with evenly distributed gaps in all the bearings.

The turbine may be adapted to different levels of flow by including a restricting ring in the pipe 12 or liner. If a very low flow is anticipated then, the main opening may be sealed with a plug such that all the fluid flows through the turbine.

In normal operating conditions, the main part of the fluid flows through the cylindrical central section 17.

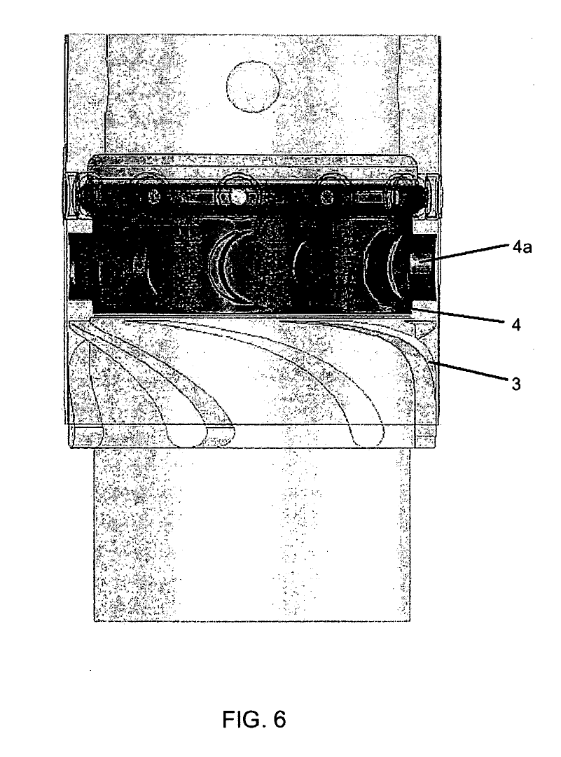

FIG. 6 shows an alternative design of the assembly of the invention where the flow shapers 3 are designed to form a fluid flow rotating almost without any component of flow in an axial direction in relation to the longitudinal direction of the apparatus. The turbine 4 is shown with curved turbine blades 4a. The turbine blades 4a imposes almost no axial force on the turbine and the fluid is thrown out from the turbine almost without any rotation at the highest rate of efficiency.

The shown invention may be designed as a heavy-wall tube that is suspended or assembled in a casing or liner of a petroleum well, normally in a standard nipple or sleeve, possibly using frictional fixing elements and seals or packers. The turbine may be designed as a freely running, wide ring. The shown embodiment shows three ring magnets 6a, 6b and 6c that are assembled in the turbine ring, but a higher or lower number of magnets may of course be used. The ring magnets will induce a current in the pick up coils 7a, 7b and 7c that are fixed in the fixed tubular shaft or housing 13. In the shown embodiments there are three rings to generate a three phase current. This is practical in terms of control when a direct current is needed because it reduces the need for capacitances. The generator may be built with a minimum of iron to reduce magnetic sticking if the generator is displaced from the centre position.

1-10. (canceled)

11. A power generating apparatus, for generating power from a fluid flowing in a pipe, including a cylindrical body, and an annular turbine with turbine blades for driving an electric generator,
characterized in:
magnetic bearings and/or fluid bearings for supporting the turbine;
a central flow passage extending through the entire power generating apparatus;
an inlet cyclone including a first static flow shaper with one or more guide vanes and a cyclone chamber to concentrate contamination of solid particles in a flow along an outer circumference of the apparatus.

12. The apparatus according to claim 11, further including second static flow shapers to further accelerate the flow of fluid to provide a rotating flow that will impinge on the turbine blades to rotate the turbine.

13. The apparatus according to claim 11, wherein the central flow passage of the cylindrical body is 100 mm in inner diameter for allowing the passing of downhole tools.

14. The apparatus according to claim 11, wherein the bearings are fluid bearings, and fluid for the fluid bearings is substantially solid free fluid leaving the cyclone chamber.

15. The apparatus according to claim 14, wherein the fluid bearings are both radial and thrust supporting fluid bearings that move the turbine towards a radial and an axial central position.

16. The apparatus according to claim 14, wherein the fluid pressure for the radial and thrust supporting fluid bearings is provided by the pressure differential between an inlet side and an outlet side across the turbine.

17. The apparatus according to claim 12, wherein the second static flow shapers are designed to form a fluid flow rotating almost without any component of flow in an axial direction in relation to the longitudinal direction of the apparatus to optimize fluid angle of attack and to minimize thrust forces and a net radial bearing force.

18. The apparatus according to claim 11, wherein leading and trailing edges of the turbine blades are symmetrical.

19. The apparatus according to claim 11, wherein the turbine and a stator are magnetically balanced to provide radial suspension reducing radial bearing requirements.

20. The apparatus according to claim 11, wherein the cylindrical body is designed to be locked into the pipe, and can be inserted into the pipe on a wire line or coiled tubing.

21. The apparatus according to claim 11, further including an electronic power controller and/or control means to alter the ratio of flow between the turbine and the central flow passage.
